(19) United States
(12) Patent Application Publication
(10) Pub. No.: US 2026/0280719 A1
(43) Pub. Date: Sep. 17, 2026

(54) OPTICAL RECEIVER AND SIGNAL PROCESSING METHOD

(71) Applicant: NTT, Inc, Tokyo (JP)

(72) Inventors: Masanori NAKAMURA, Musashino-shi, Tokyo (JP); Minami TAKAHASHI, Musashino-shi, Tokyo (JP); Mitsuteru YOSHIDA, Musashino-shi, Tokyo (JP); Yoshiaki KISAKA, Musashino-shi, Tokyo (JP)

(21) Appl. No.: 18/877,588

(22) PCT Filed: Jun. 29, 2022
(86) PCT No.: PCT/JP2022/026013

§ 371 Date: Dec. 20, 2024

(51) Int. Cl. H04B 10/61

(52) U.S. Cl. CPC H04B 10/613; H04B 10/612; H04B 10/6165; H04B 10/6166

(57) ABSTRACT

There is provided an optical receiver including: an acquisition unit that acquires a signal indicating an in-phase component and a signal indicating a quadrature component for each of polarized waves of received light; and an error detection unit that detects, as an angle error, a deviation in orthogonality between the in-phase component and the quadrature component based on the signals, the components being generated in an optical hybrid circuit that performs coherent detection of the received light, and updates a setting value to be used for compensation processing of the deviation in orthogonality in at least one of the optical hybrid circuit or an equalizer based on the angle error.

### TECHNICAL FIELD

The present invention relates to an optical receiver and a signal processing method.

### BACKGROUND ART

Digital coherent optical communication can implement large-capacity and long-distance optical transmission by compensating for signal distortion occurring in an optical transmitter, an optical fiber transmission line, and an optical receiver by digital signal processing. Recently, in order to further increase the capacity of optical transmission, it has been required to improve the accuracy of imperfection compensation in an optical transceiver. For example, an optical transmission characteristic compensation system described in Patent Literature 1 estimates imperfection of the optical transceiver by using a known reference signal and performs imperfection compensation based on an estimation result.

### CITATION LIST

### Patent Literature

Patent Literature 1: JP 2019-47397 A

### Non Patent Literature

Non Patent Literature 1: L. Anttila et. al., “Circularity-Based I/Q Imbalance Compensation in Wideband Direct-Conversion Receivers,” IEEE TRANSACTIONS ON VEHICULAR TECHNOLOGY, Vol. 57, No. 4, pp. 2099-2113, July 2008.

### SUMMARY OF INVENTION

### Technical Problem

In the related art, there is a problem that IQ orthogonality of an optical hybrid circuit of the receiver may change due to, for example, a temperature change, a wavelength change, and the like. In order to solve such a problem, a compensation technique for compensating for influences of a 90-degree error and an IQ gain imbalance has been studied. However, in such a compensation technique, it is necessary to separately provide a new equalizer. As a result, there is a problem that a configuration of the digital signal processing becomes complicated.

In view of the above circumstances, an object of the present invention is to provide a technique capable of improving accuracy of estimation of an IQ orthogonality error and implementing optical communication with a higher quality while preventing a configuration of digital signal processing from being complicated.

### Solution to Problem

According to an aspect of the present invention, there is provided an optical receiver including: an acquisition unit that acquires a signal indicating an in-phase component and a signal indicating a quadrature component for each of polarized waves of received light; and an error detection unit that detects, as an angle error, a deviation in orthogonality between the in-phase component and the quadrature component based on the signals, the components being generated in an optical hybrid circuit that performs coherent detection of the received light, and updates a setting value to be used for compensation processing of the deviation in orthogonality in at least one of the optical hybrid circuit or an equalizer based on the angle error.

Further, according to another aspect of the present invention, there is provided a signal processing method causing a computer of an optical receiver to execute a process including: an acquisition step of acquiring an electrical signal indicating an in-phase component and an electrical signal indicating a quadrature component for each of polarized waves of received light; a detection step of detecting, as an angle error, a deviation in orthogonality between the in-phase component and the quadrature component based on the electrical signals, the components being generated in an optical hybrid circuit that performs coherent detection of the received light; and an update step of updating a setting value to be used for compensation processing of the deviation in orthogonality in at least one of the optical hybrid circuit or an equalizer based on the angle error.

### Advantageous Effects of Invention

According to the present invention, it is possible to improve accuracy of estimation of an IQ orthogonality error while preventing a configuration of digital signal processing from being complicated. Thereby, it is possible to implement optical communication with a higher quality.

### BRIEF DESCRIPTION OF DRAWINGS

FIG. 1 is a block diagram illustrating an overall configuration of an optical receiver 1 according to a first embodiment of the present invention.

FIG. 2 is a block diagram illustrating a configuration of a 90-degree error detection unit 24 according to the first embodiment of the present invention.

FIG. 3 is a flowchart illustrating an operation of the optical receiver 1 according to the first embodiment of the present invention.

FIG. 4 is a graph illustrating a result of a simulation related to estimation of a 90-degree error amount of an IQ orthogonal deviation according to the configuration of the 90-degree error detection unit 24 in the first embodiment of the present invention.

FIG. 5 is a block diagram illustrating a configuration of a 90-degree error detection unit 24a according to a second embodiment of the present invention.

FIG. 6 is a flowchart illustrating an operation of an optical receiver 1 according to the second embodiment of the present invention.

### DESCRIPTION OF EMBODIMENTS

Hereinafter, an optical receiver and a signal processing method according to an embodiment will be described with reference to the drawings.

The present invention relates to a technique for performing compensation of a deviation in IQ orthogonality of an optical receiver of an optical transmission system of digital coherent optical communication. The digital coherent optical communication is a communication method using a property of a light wave. Note that coherent means having coherence. In the field of communication, frequency modulation or phase modulation can be used. The digital coherent optical communication has a higher reception sensitivity than an intensity modulation (IM)-direct detection (DD) method in the related art that detects a change in intensity of signal light by a photodiode, and is a basic technique for wavelength division multiplexing communication that enables large-capacity information transmission at terabits per second.

For example, an optical transmission system having a quadrature phase shift keying (QPSK) type, which is one of modulation types, uses phase information of light, and thus, can transmit twice as much information as an IM-DD type optical transmission system. Further, by including pieces of information different from each other in an X polarized wave and a Y polarized wave based on a property that two orthogonal optical waves do not intersect with each other, it is possible to transmit twice the information to the QPSK type optical transmission system. Such a modulation type is referred to as a dual polarization (DP)-QPSK type. The DP-QPSK type optical transmission system can transmit four times as much information in the same signal band as the IM-DD type optical transmission system in the related art.

An optical transmitter of the DP-QPSK type optical transmission system converts digital signals “0” and “1” into in-phase (I) components and quadrature (Q) components of an X polarized wave (vertical polarized wave) and a Y polarized wave (horizontal polarized wave), respectively. The optical transmitter drives a Mach-Zehnder modulator using the electrical signals of XI, XQ, YI, and YQ, and further generates an optical signal that is phase-modulated and dual-polarized by performing polarization combination.

On the other hand, an optical receiver of the DP-QPSK type optical transmission system performs polarization separation on the signal light that is phase-modulated and dual-polarized. In addition, the optical receiver detects the I component and the Q component of each of the X polarized wave and the Y polarized wave by causing the signal light to interfere with laser light (local light) transmitted from a local oscillation laser included in a reception unit. Since a signal is detected by causing the signal light to interfere with the local light, this is called coherent detection.

The optical receiver converts the detected I component and the detected Q component of each of the X polarized wave and Y polarized wave into electrical signals by a light receiving element. In addition, the optical receiver converts the I component and the Q component into digital sampling data by an analog-to-digital converter (ADC) having a high sampling rate. In addition, the optical receiver performs advanced signal equalization on the digital sampling data by digital signal processing using a digital signal processor (DSP). Thereby, the optical receiver can correct signal distortion due to wavelength dispersion, polarization dispersion, and the like related to a characteristic of an optical fiber.

An optical receiver 1 according to an embodiment of the present invention to be described below includes a 90-degree error detection unit that calculates a 90-degree error amount of an IQ orthogonal deviation of an optical hybrid circuit as angle information (an angle error) and updates a receiver compensation value (initially set value) of at least one of the optical hybrid circuit or an equalizer by adding the calculated value and the receiver compensation value which is initially set.

With such a configuration, the optical receiver 1 according to the embodiment of the present invention can estimate the 90-degree error amount of the IQ orthogonal deviation of the optical hybrid circuit without using a known reference signal, and can feed back the estimated value to the optical hybrid circuit or update the compensation value to be used in the digital signal processing unit (equalizer) having a configuration in the related art by using the estimated value.

Thereby, the optical receiver 1 according to the embodiment of the present invention can perform compensation of the IQ orthogonality error of the optical hybrid circuit with higher accuracy. Thus, it is possible to reduce a deterioration in signal quality and implement optical communication with a higher quality. In addition, in the optical transmission system including the optical receiver 1 according to the embodiment of the present invention, it is not necessary to use a known reference signal, and thus, it is possible to perform compensation of an IQ orthogonality error even during an operation of the optical transmission system.

### First Embodiment

Hereinafter, a configuration of an optical receiver and a signal processing method according to a first embodiment will be described.

### [Overall Configuration of Optical Receiver]

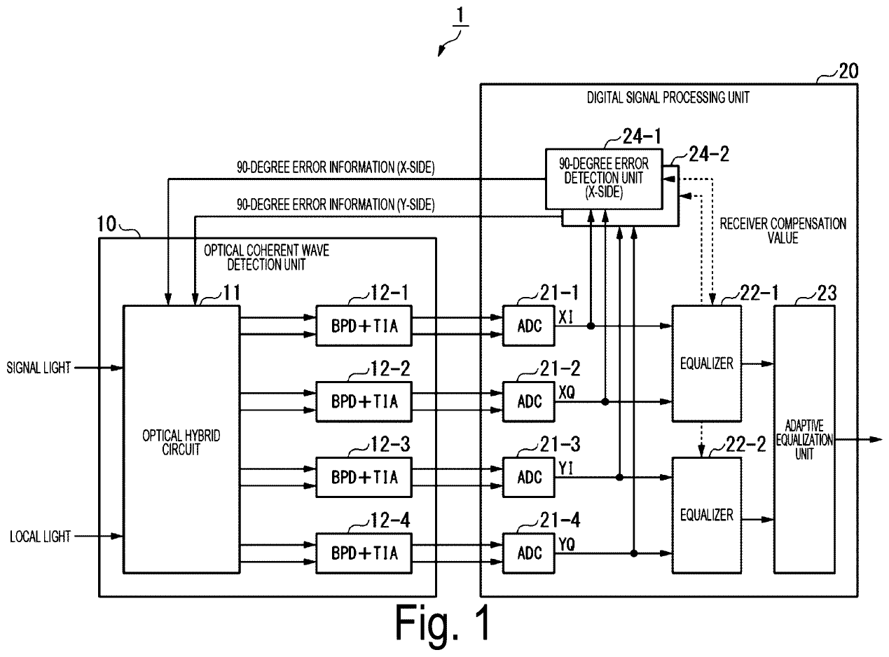

Hereinafter, an overall configuration of an optical receiver 1 according to the first embodiment will be described. FIG. 1 is a block diagram illustrating an overall configuration of an optical receiver 1 according to the first embodiment of the present invention. As illustrated in FIG. 1, the optical receiver 1 includes an optical coherent detection unit 10 and a digital signal processing unit 20.

The optical coherent detection unit 10 includes an optical hybrid circuit 11, and four sets of balanced photo detectors (BPDs) and trans-impedance amplifiers (TIAs) 12 (hereinafter, referred to as “BPDs+TIAs 12”) (BPD+TIA 12-1 to BPD+TIA 12-4).

The digital signal processing unit 20 includes four analog-to-digital converters 21 (hereinafter, referred to as “ADCs 21”) (ADC 21-1 to ADC 21-4), two equalizers 22 (an equalizer 22-1 and an equalizer 22-2), an adaptive equalization unit 23, and two 90-degree error detection units 24 (a 90-degree error detection unit (X side) 24-1 and a 90-degree error detection unit (Y side) 24-2).

The optical hybrid circuit 11 receives signal light which is transmitted from an opposing optical transmitter (not illustrated) and is transmitted through an optical transmission line (not illustrated). In addition, the optical hybrid circuit 11 receives local light transmitted from a local oscillation laser (not illustrated) included in the optical receiver 1. The optical hybrid circuit 11 performs coherent detection by causing the received signal light (hereinafter, also referred to as “received light”) to interfere with the local light. The optical hybrid circuit 11 converts the received light into four components of an I component of an X polarized wave, a Q component of an X polarized wave, an I component of a Y polarized wave, and a Q component of a Y polarized wave by coherent detection.

The optical hybrid circuit 11 respectively outputs the generated four components to the corresponding four BPDs+TIAs 12. Specifically, the optical hybrid circuit 11 outputs an I component of an X polarized wave to the BPD+TIA 12-1, outputs a Q component of an X polarized wave to the BPD+TIA 12-2, outputs an I component of a Y polarized wave to the BPD+TIA 12-3, and outputs a Q component of a Y polarized wave to the BPD+TIA 12-4.

The BPDs+TIAs 12 convert the optical signal which is input from the optical hybrid circuit 11 into an electrical signal, and amplify the electrical signal. Each of the four BPDs+TIAs 12 outputs the electrical signal to the corresponding ADC 21. Specifically, the BPD+TIA 12-1 outputs the electrical signal to the ADC 21-1, the BPD+TIA 12-2 outputs the electrical signal to the ADC 21-2, the BPD+TIA 12-3 outputs the electrical signal to the ADC 21-3, and the BPD+TIA 12-4 outputs the electrical signal to the ADC 21-4.

Each of the four ADCs 21 converts the electrical signal which is input from the BPD+TIA 12 into a digital signal, and outputs the converted digital signal to the corresponding equalizer 22 and the corresponding 90-degree error detection unit 24.

Specifically, the ADC 21-1 converts the electrical signal, which is input from the BPA+TIA 12-1 and has the I component of the X polarized wave, into a digital signal, and outputs the converted digital signal which has the I component of the X polarized wave to the equalizer 22-1 and the 90-degree error detection unit (X side) 24-1. Further, the ADC 21-2 converts the electrical signal, which is input from the BPA+TIA 12-2 and has the Q component of the X polarized wave, into a digital signal, and outputs the converted digital signal which has the Q component of the X polarized wave to the equalizer 22-1 and the 90-degree error detection unit (X side) 24-1. Further, the ADC 21-3 converts the electrical signal, which is input from the BPA+TIA 12-3 and has the I component of the Y polarized wave, into a digital signal, and outputs the converted digital signal which has the I component of the Y polarized wave to the equalizer 22-2 and the 90-degree error detection unit (Y side) 24-2. Further, the ADC 21-4 converts the electrical signal, which is input from the BPA+TIA 12-4 and has the Q component of the Y polarized wave, into a digital signal, and outputs the converted digital signal which has the Q component of the Y polarized wave to the equalizer 22-2 and the 90-degree error detection unit (Y side) 24-2.

The equalizer 22 performs, for each of the polarized waves, compensation of signal distortion due to imperfection of the optical coherent detection unit 10 and compensation of signal distortion due to wavelength dispersion occurring in the optical transmission line (optical fiber), on the digital signals for each of the polarized waves input from the corresponding two ADCs 21. The imperfection mentioned herein includes, for example, IQ gain imbalance, IQ skew, and a 90-degree error. The equalizer 22 outputs the compensated digital signal for each of the polarized waves to the adaptive equalization unit 23.

Specifically, the equalizer 22-1 performs compensation of signal distortion of the X polarized wave due to imperfection of the optical coherent detection unit 10 and compensation of signal distortion of the X polarized wave due to wavelength dispersion occurring in the optical transmission line, based on the digital signal which is input from the ADC 21-1 and has the I component of the X polarized wave and the digital signal which is input from the ADC 21-2 and has the Q component of the X polarized wave. In addition, the equalizer 22-1 outputs the digital signal of the compensated X polarized wave to the adaptive equalization unit 23. In addition, the equalizer 22-2 performs compensation of signal distortion of the Y polarized wave due to imperfection of the optical coherent detection unit 10 and compensation of signal distortion of the Y polarized wave due to wavelength dispersion occurring in the optical transmission line, based on the digital signal which is input from the ADC 21-3 and has the I component of the Y polarized wave and the digital signal which is input from the ADC 21-4 and has the Q component of the Y polarized wave. In addition, the equalizer 22-2 outputs the digital signal of the compensated Y polarized wave to the adaptive equalization unit 23.

The adaptive equalization unit 23 performs compensation of a channel response (for example, rotation or the like of a polarized wave) that dynamically varies at a high speed, on the digital signal which is input from the equalizer 22 for each of the polarized waves. Specifically, the adaptive equalization unit 23 performs, on the digital signal, compensation of a channel response that dynamically varies at a high speed, based on the digital signal of the X polarized wave that is input from the equalizer 22-1 and the digital signal of the Y polarized wave that is input from the equalizer 22-2. The adaptive equalization unit 23 outputs the digital signal for which compensation of a channel response is performed, for example, to an external device or the like.

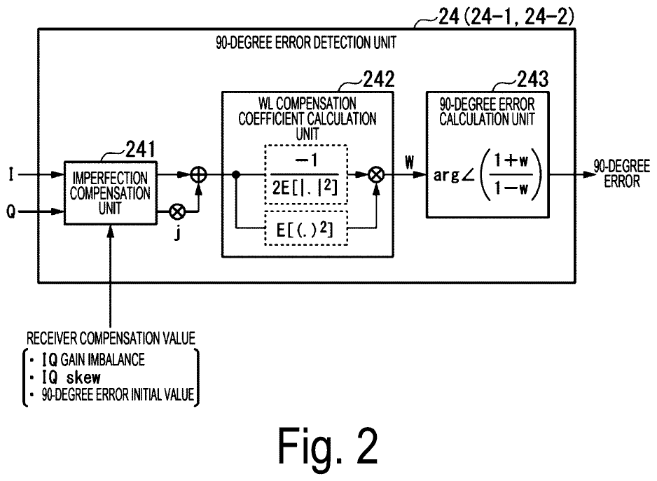

A configuration of the 90-degree error detection unit 24 will be described in detail below with reference to FIG. 2.

### [Configuration of 90-Degree Error Detection Unit]

Hereinafter, a configuration of the 90-degree error detection unit 24 will be described. The 90-degree error detection unit 24 calculates a 90-degree error amount of the IQ orthogonal deviation as angle information, and adds the calculated value to the 90-degree error amount of the IQ orthogonal deviation of the receiver compensation value (initially set in the optical hybrid circuit 11 and the equalizer 22). Thereby, the 90-degree error amount of the IQ orthogonal deviation that is set in the optical hybrid circuit 11 and the equalizer 22 is updated.

FIG. 2 is a block diagram illustrating a configuration of the 90-degree error detection unit 24 according to the first embodiment of the present invention. As illustrated in FIG. 2, the 90-degree error detection unit 24 includes an imperfection compensation unit 241, a Widely Linear compensation coefficient calculation unit 242 (hereinafter, referred to as a “WL compensation coefficient calculation unit 242”), and a 90-degree error calculation unit 243.

Note that the configuration of the 90-degree error detection unit (X side) 24-1 is similar to the configuration of the 90-degree error detection unit (Y side) 24-2.

The imperfection compensation unit 241 acquires the digital signals of the I component and the Q component of the corresponding polarized wave from the corresponding two ADCs 21. In addition, the imperfection compensation unit 241 acquires the receiver compensation value of the corresponding polarized wave from the corresponding equalizer 22.

Specifically, the imperfection compensation unit 241 of the 90-degree error detection unit (X side) 24-1 acquires the digital signal of the I component of the X polarized wave from the ADC 21-1, and acquires the digital signal of the Q component of the X polarized wave from the ADC 21-2. In addition, the imperfection compensation unit 241 of the 90-degree error detection unit (X side) 24-1 acquires the receiver compensation value of the X polarized wave from the equalizer 22-1. Similarly, the imperfection compensation unit 241 of the 90-degree error detection unit (Y side) 24-2 acquires the digital signal of the I component of the Y polarized wave from the ADC 21-3, and acquires the digital signal of the Q component of the Y polarized wave from the ADC 21-4. In addition, the imperfection compensation unit 241 of the 90-degree error detection unit (Y side) 24-2 acquires the receiver compensation value of the Y polarized wave from the equalizer 22-2.

The receiver compensation value includes an IQ gain imbalance value, an IQ skew value, and an initial setting value of the 90-degree error amount of the IQ orthogonal deviation.

The imperfection compensation unit 241 performs imperfection compensation on the digital signals of the I component and the Q component for each of the polarized waves by using the acquired receiver compensation value for each of the polarized waves. Specifically, the imperfection compensation unit 241 of the 90-degree error detection unit (X side) 24-1 performs imperfection compensation on the digital signals of the I component and the Q component of the X polarized wave by using the acquired receiver compensation value of the X polarized wave. Similarly, the imperfection compensation unit 241 of the 90-degree error detection unit (Y side) 24-2 performs imperfection compensation on the digital signals of the I component and the Q component of the Y polarized wave by using the acquired receiver compensation value of the Y polarized wave.

The imperfection compensation unit 241 outputs the digital signals of the I component and the Q component for each of the polarized waves for which imperfection compensation is performed. For the digital signal of the Q component that is output, a phase of the Q component (quadrature component) is advanced by 90 degrees on a complex plane by an imaginary-unit multiplier j. Thereafter, an output of the imaginary-unit multiplier j is added to the digital signal of the I component by an adder. Thereby, a reception signal of the X polarized wave (vertically polarized wave) or the Y polarized wave (horizontally polarized wave) is generated, the reception signal having the I component (in-phase component) as a real component and the Q component (quadrature component) as an imaginary component. The reception signal is input to the WL compensation coefficient calculation unit 242.

Specifically, the imperfection compensation unit 241 of the 90-degree error detection unit (X side) 24-1 outputs the digital signals of the I component and the Q component of the X polarized wave for which imperfection compensation is performed. In addition, a reception signal of the X polarized wave (vertically polarized wave) having the I component as a real component and the Q component as an imaginary component is generated, and the reception signal is input to the WL compensation coefficient calculation unit 242. Similarly, the imperfection compensation unit 241 of the 90-degree error detection unit (Y side) 24-2 outputs the digital signals of the I component and the Q component of the Y polarized wave for which imperfection compensation is performed. In addition, a reception signal of the Y polarized wave (horizontally polarized wave) having the I component as a real component and the Q component as an imaginary component is generated, and the reception signal is input to the WL compensation coefficient calculation unit 242.

The WL compensation coefficient calculation unit 242 calculates a WL (widely linear) compensation coefficient W of the reception signal that is input from the adder. The WL compensation coefficient W mentioned here is a coefficient that compensates for a deviation in IQ symmetry of the reception signal. The WL compensation coefficient W can be obtained by the method described in Non Patent Literature 1. Specifically, the WL compensation coefficient W can be obtained by using a following expression (1) corresponding to the expression (24) of Non Patent Literature 1.

$$W = - E [ {( . )}^{2} ] / 2 E [ \vert . \vert ] \qquad ( 1 )$$

Here, |.|represents an absolute value, and E[.] represents an expected value.

The WL compensation coefficient calculation unit 242 outputs the calculated value of the WL compensation coefficient W to the 90-degree error calculation unit 243.

The 90-degree error calculation unit 243 extracts only the 90-degree error amount of the IQ orthogonal deviation from the value of the WL compensation coefficient W that is input from the WL compensation coefficient calculation unit 242. The 90-degree error calculation unit 243 calculates a 90-degree error amount of the IQ orthogonal deviation as angle information. Here, a 90-degree error θ is calculated by using a following expression (2).

$$θ = arg ∠ [ ( 1 + w ) / ( 1 - w ) ] \qquad ( 2 )$$

Here, arg ∠[.] represents a deflection angle of a complex number.

The 90-degree error calculation unit 243 adds the calculated value to the 90-degree error amount of the IQ orthogonal deviation of the receiver compensation value (initially set in the optical hybrid circuit 11 and the equalizer 22). Thereby, the 90-degree error amount of the IQ orthogonal deviation that is set in the optical hybrid circuit 11 and the equalizer 22 is updated.

The update of the 90-degree error amount of the IQ orthogonal deviation is performed for each of the polarized waves. Specifically, the 90-degree error calculation unit 243 of the 90-degree error detection unit (X side) 24-1 extracts only the 90-degree error amount of the IQ orthogonal deviation of the X polarized wave from the WL compensation coefficient W of the X polarized wave that is input from the WL compensation coefficient calculation unit 242. The 90-degree error calculation unit 243 calculates a 90-degree error amount of the IQ orthogonal deviation of the X polarized wave as angle information. The 90-degree error calculation unit 243 adds the calculated value to the 90-degree error amount of the IQ orthogonal deviation of the receiver compensation value of the X polarized wave (initially set in the optical hybrid circuit 11 and the equalizer 22-1). Thereby, the 90-degree error amount of the IQ orthogonal deviation of the X polarized wave that is set in the optical hybrid circuit 11 and the equalizer 22-1 is updated. Similarly, the 90-degree error calculation unit 243 of the 90-degree error detection unit (Y side) 24-2 extracts only the 90-degree error amount of the IQ orthogonal deviation of the Y polarized wave from the WL compensation coefficient W of the Y polarized wave that is input from the WL compensation coefficient calculation unit 242. The 90-degree error calculation unit 243 calculates a 90-degree error amount of the IQ orthogonal deviation of the Y polarized wave as angle information. The 90-degree error calculation unit 243 adds the calculated value to the 90-degree error amount of the IQ orthogonal deviation of the receiver compensation value of the Y polarized wave (initially set in the optical hybrid circuit 11 and the equalizer 22-2). Thereby, the 90-degree error amount of the IQ orthogonal deviation of the Y polarized wave that is set in the optical hybrid circuit 11 and the equalizer 22-2 is updated.

Note that the method described in Non Patent Literature 1 has a configuration in which the WL compensation coefficient W is applied to the reception signal. That is, the imperfection compensation method described in Non Patent Literature 1 has a configuration that compensates for influences by the 90-degree error amount of the IQ orthogonal deviation, the IQ gain imbalance, and the like on the reception signal. Therefore, the imperfection compensation method described in Non Patent Literature 1 does not have a configuration that calculates the 90-degree error amount of the IQ orthogonal deviation as angle information (angle error).

On the other hand, unlike the imperfection compensation method described in Non Patent Literature 1, the optical receiver 1 according to the first embodiment does not directly apply the WL compensation coefficient W to the reception signal. As described above, the 90-degree error calculation unit 243 of the optical receiver 1 according to the first embodiment extracts only the 90-degree error amount of the IQ orthogonal deviation from the WL compensation coefficient W. The 90-degree error calculation unit 243 calculates a 90-degree error amount of the IQ orthogonal deviation as angle information (angle error). In addition, the 90-degree error calculation unit 243 adds the calculated value and the 90-degree error amount of the IQ orthogonal deviation of the receiver compensation value that is initially set in at least one of the optical hybrid circuit 11 or the equalizer 22. Thereby, the 90-degree error amount of the IQ orthogonal deviation of the receiver compensation value that is initially set is updated.

With such a configuration, the optical receiver 1 according to the first embodiment can perform not only compensation of the 90-degree error amount of the IQ orthogonal deviation in the digital signal processing unit 20 (the equalizer 22) but also compensation of the 90-degree error amount of the IQ orthogonal deviation in the optical hybrid circuit 11. In particular, in a case where the 90-degree error of the IQ orthogonal deviation in the optical hybrid circuit 11 is large, an effect of the compensation in the digital signal processing unit 20 is reduced. Therefore, even in such a case, the optical receiver 1 according to the first embodiment can prevent the effect of the compensation in the digital signal processing unit 20 from being reduced, and can implement optical communication with a higher quality.

### [Operation of Optical Receiver]

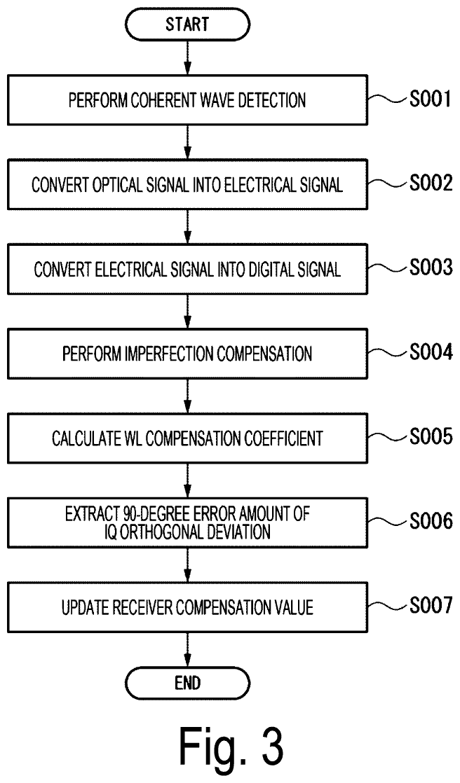

Hereinafter, an example of an operation of the optical receiver 1 related to the update of the receiver compensation value will be described. FIG. 3 is a flowchart illustrating an operation of the optical receiver 1 according to the first embodiment of the present invention.

The optical hybrid circuit 11 receives signal light which is transmitted from an opposing optical transmitter (not illustrated) and is transmitted through an optical transmission line (not illustrated). In addition, the optical hybrid circuit 11 receives local light transmitted from a local oscillation laser (not illustrated) included in the optical receiver 1. The optical hybrid circuit 11 performs coherent detection by causing the received signal light (received light) to interfere with the local light (step S001). The optical hybrid circuit 11 converts the received light into four components of an I component of an X polarized wave, a Q component of an X polarized wave, an I component of a Y polarized wave, and a Q component of a Y polarized wave by coherent detection. The optical hybrid circuit 11 respectively outputs the generated four components to the corresponding four BPDs+TIAs 12.

The BPDs+TIAs 12 convert the optical signal which is input from the optical hybrid circuit 11 into an electrical signal, and amplify the electrical signal (step S002). Each of the four BPDs+TIAs 12 outputs the electrical signal to the corresponding ADC 21.

Each of the four ADCs 21 converts the electrical signal which is input from the BPD+TIA 12 into a digital signal, and outputs the converted digital signal to the corresponding equalizer 22 and the corresponding 90-degree error detection unit 24 (step S003).

The imperfection compensation unit 241 of the 90-degree error detection unit 24 acquires the digital signals of the I component and the Q component of the corresponding polarized wave from the corresponding two ADCs 21. In addition, the imperfection compensation unit 241 acquires the receiver compensation value of the corresponding polarized wave from the corresponding equalizer 22. The receiver compensation value includes an initial setting value of the 90-degree error amount of the IQ orthogonal deviation. The imperfection compensation unit 241 performs imperfection compensation on the digital signals of the I component and the Q component for each of the polarized waves by using the acquired receiver compensation value for each of the polarized waves (step S004).

The imperfection compensation unit 241 outputs the digital signals of the I component and the Q component for each of the polarized waves for which imperfection compensation is performed. For the digital signal of the Q component that is output, a phase of the Q component is advanced by 90 degrees on a complex plane by an imaginary-unit multiplier j. Thereafter, an output of the imaginary-unit multiplier j is added to the digital signal of the I component by an adder. Thereby, a reception signal of each of the X polarized wave and the Y polarized wave is generated, the reception signal having the I component as a real component and the Q component as an imaginary component. The reception signal is input to the WL compensation coefficient calculation unit 242.

The WL compensation coefficient calculation unit 242 calculates a WL (widely linear) compensation coefficient W of the reception signal that is input from the adder (step S005). The WL compensation coefficient calculation unit 242 outputs the calculated WL compensation coefficient W to the 90-degree error calculation unit 243.

The 90-degree error calculation unit 243 extracts only the 90-degree error amount of the IQ orthogonal deviation from the WL compensation coefficient W that is input from the WL compensation coefficient calculation unit 242 (step S006). The 90-degree error calculation unit 243 calculates a 90-degree error amount of the IQ orthogonal deviation as angle information.

The 90-degree error calculation unit 243 adds the calculated value to the 90-degree error amount of the IQ orthogonal deviation of the receiver compensation value (initially set in the optical hybrid circuit 11 and the equalizer 22). Thereby, the 90-degree error amount of the IQ orthogonal deviation of the receiver compensation value that is set in the optical hybrid circuit 11 and the equalizer 22 is updated (step S007).

In this way, the operation of the optical receiver 1 that is related to update of the receiver compensation value and is illustrated in the flowchart of FIG. 3 is ended.

### [Simulation Result]

Hereinafter, a result of a simulation related to estimation of the 90-degree error amount of the IQ orthogonal deviation will be described, the simulation being performed based on the configuration of the 90-degree error detection unit 24.

In this simulation, the 90-degree error detection unit 24 illustrated in FIG. 2 estimates the 90-degree error amount of the IQ orthogonal deviation by using a 16 quadrature amplitude modulation (QAM) signal. In addition, in this simulation, a load is applied to the 90-degree angle between the polarized waves of the optical hybrid circuit 11 while changing a value of the load. Further, in this simulation, the estimated value that is output from the 90-degree error detection unit 24 is observed for each load value, and estimation accuracy is confirmed by comparing the load value with the estimated value.

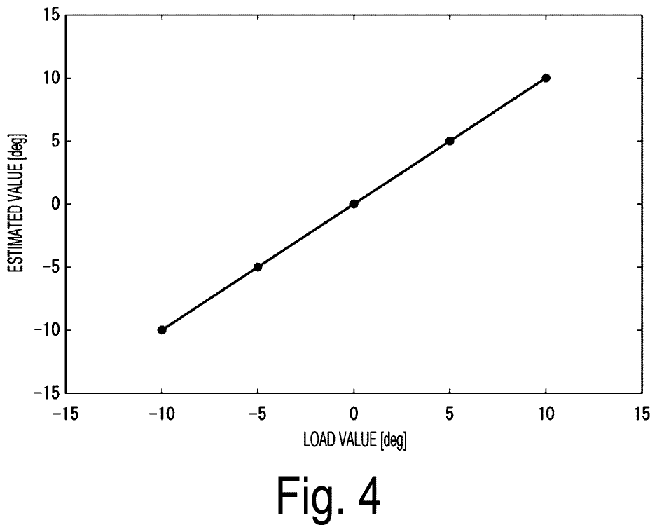

FIG. 4 is a graph illustrating a result of a simulation related to estimation of the 90-degree error amount of the IQ orthogonal deviation according to the configuration of the 90-degree error detection unit 24 in the first embodiment of the present invention. In the graph illustrated in FIG. 4, a horizontal axis represents a load value [unit: deg] applied to the 90-degree angle between the polarized waves of the optical hybrid circuit 11, and a vertical axis represents an estimated value [unit: deg] output by the 90-degree error detection unit 24.

As illustrated in FIG. 4, the load value and the estimated value substantially coincide with each other, and it has been confirmed that the 90-degree error amount of the IQ orthogonal deviation can be estimated by the configuration of the 90-degree error detection unit 24 according to the first embodiment of the present invention.

### Second Embodiment

Hereinafter, a configuration of an optical receiver and a signal processing method according to a second embodiment will be described.

Note that the overall configuration of the optical receiver 1 according to the second embodiment is similar to the overall configuration of the optical receiver 1 according to the first embodiment described above with reference to the overall configuration diagram of FIG. 1, and thus a description thereof will be omitted.

### [Configuration of 90-Degree Error Detection Unit]

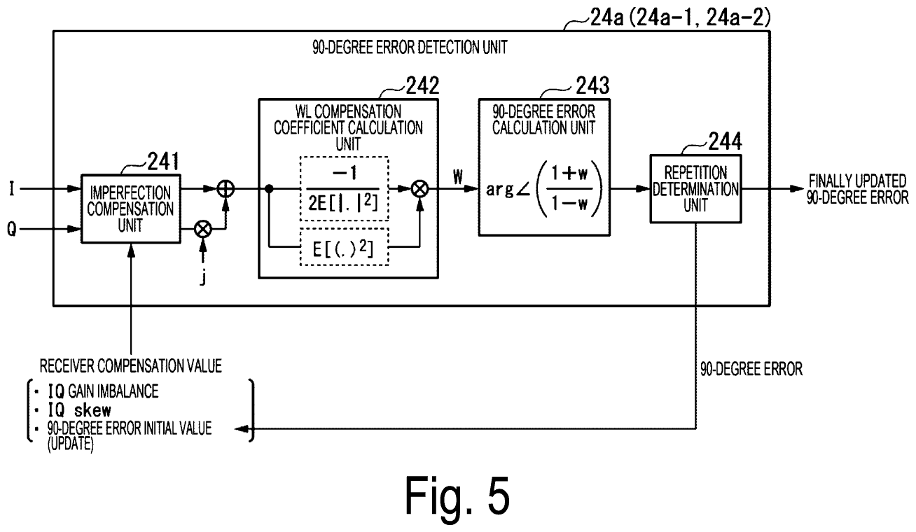

Hereinafter, a configuration of the 90-degree error detection unit 24a of the optical receiver 1 according to the second embodiment will be described. FIG. 5 is a block diagram illustrating a configuration of the 90-degree error detection unit 24a according to the second embodiment of the present invention.

The configuration of the 90-degree error detection unit 24a according to the second embodiment illustrated in FIG. 5 is different from the configuration of the 90-degree error detection unit 24 according to the first embodiment illustrated in FIG. 2 in that a repetition determination unit 244 is further included. Note that the configurations of the imperfection compensation unit 241, the WL compensation coefficient calculation unit 242, and the 90-degree error calculation unit 243 are similar to the configurations included in the 90-degree error detection unit 24 according to the first embodiment described above. Thus, the units are denoted by the same reference numerals, and a description thereof will be omitted.

The 90-degree error calculation unit 243 calculates a 90-degree error amount of the IQ orthogonal deviation as angle information, and outputs the calculated value to the repetition determination unit 244. The repetition determination unit 244 determines whether to repeatedly execute processing of calculating the 90-degree error amount of the IQ orthogonal deviation, the processing being performed by the imperfection compensation unit 241, the WL compensation coefficient calculation unit 242, and the 90-degree error calculation unit 243.

In a case where it is determined to repeatedly execute the processing of calculating the 90-degree error amount of the IQ orthogonal deviation, the repetition determination unit 244 outputs a value of the 90-degree error amount of the IQ orthogonal deviation that is input from the 90-degree error calculation unit 243 to the imperfection compensation unit 241. In a case where the value of the 90-degree error amount of the IQ orthogonal deviation is input from the 90-degree error calculation unit 243, the imperfection compensation unit 241 performs imperfection compensation on the digital signals of the I component and the Q component by using the receiver compensation value including the input value of the 90-degree error amount of the IQ orthogonal deviation. Thereafter, the processing of calculating the 90-degree error amount of the IQ orthogonal deviation is repeated.

On the other hand, in a case where it is determined not to repeatedly execute the processing of calculating the 90-degree error amount of the IQ orthogonal deviation, the repetition determination unit 244 sets the value of the 90-degree error amount of the IQ orthogonal deviation that is input from the 90-degree error calculation unit 243 to a value that is finally updated. The 90-degree error calculation unit 243 adds the finally updated value of the 90-degree error amount of the IQ orthogonal deviation to the 90-degree error amount of the IQ orthogonal deviation of the receiver compensation value (initially set in the optical hybrid circuit 11 and the equalizer 22). Thereby, the 90-degree error amount of the IQ orthogonal deviation that is set in the optical hybrid circuit 11 and the equalizer 22 is updated.

For example, in a case where the value of the 90-degree error amount of the IQ orthogonal deviation that is input from the 90-degree error calculation unit 243 converges, the repetition determination unit 244 determines not to repeatedly execute the processing of calculating the 90-degree error amount of the IQ orthogonal deviation. For example, in a case where a difference between the acquired value of the 90-degree error amount of the IQ orthogonal deviation and the previously acquired value of the 90-degree error amount of the IQ orthogonal deviation is equal to or smaller than a predetermined threshold value, the repetition determination unit 244 assumes that the value of the 90-degree error amount of the IQ orthogonal deviation converges.

With such a configuration, for example, in a case where the 90-degree error of the IQ orthogonal deviation suddenly and greatly changes, the optical receiver 1 according to the second embodiment can prevent the 90-degree error amount of the IQ orthogonal deviation that is set in the optical hybrid circuit 11 and the equalizer 22 from being updated.

### [Operation of Optical Receiver]

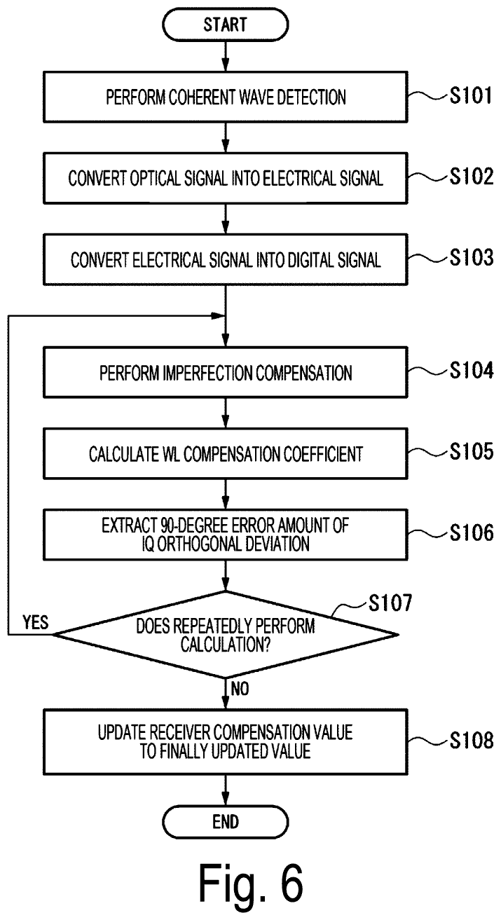

Hereinafter, an example of an operation of the optical receiver 1 related to the update of the receiver compensation value will be described. FIG. 6 is a flowchart illustrating an operation of the optical receiver 1 according to the second embodiment of the present invention.

Note that the operation of the optical receiver 1 according to the second embodiment from step S101 to step S103 in the flowchart illustrated in FIG. 6 is the same as the operation of the optical receiver 1 according to the first embodiment from step S001 to step S003 in the flowchart illustrated in FIG. 3. Thus, a description thereof will be omitted.

The imperfection compensation unit 241 of the 90-degree error detection unit 24 acquires the digital signals of the I component and the Q component of the corresponding polarized wave from the corresponding two ADCs 21. In addition, the imperfection compensation unit 241 acquires the receiver compensation value of the corresponding polarized wave from the corresponding equalizer 22. The receiver compensation value includes an initial setting value of the 90-degree error amount of the IQ orthogonal deviation. The imperfection compensation unit 241 performs imperfection compensation on the digital signals of the I component and the Q component for each of the polarized waves by using the acquired receiver compensation value for each of the polarized waves (step S104).

The imperfection compensation unit 241 outputs the digital signals of the I component and the Q component for each of the polarized waves for which imperfection compensation is performed. For the digital signal of the Q component that is output, a phase of the Q component is advanced by 90 degrees on a complex plane by an imaginary-unit multiplier j. Thereafter, an output of the imaginary-unit multiplier j is added to the digital signal of the I component by an adder. Thereby, a reception signal of each of the X polarized wave and the Y polarized wave is generated, the reception signal having the I component as a real component and the Q component as an imaginary component. The reception signal is input to the WL compensation coefficient calculation unit 242.

The WL compensation coefficient calculation unit 242 calculates a WL (widely linear) compensation coefficient W of the reception signal that is input from the adder (step S105). The WL compensation coefficient calculation unit 242 outputs the calculated WL compensation coefficient W to the 90-degree error calculation unit 243.

The 90-degree error calculation unit 243 extracts only the 90-degree error amount of the IQ orthogonal deviation from the WL compensation coefficient W that is input from the WL compensation coefficient calculation unit 242 (step S106). The 90-degree error calculation unit 243 calculates a 90-degree error amount of the IQ orthogonal deviation as angle information. The 90-degree error calculation unit 243 calculates a 90-degree error amount of the IQ orthogonal deviation as angle information, and outputs the calculated value to the repetition determination unit 244.

The repetition determination unit 244 determines whether to repeatedly execute the processing of calculating the 90-degree error amount of the IQ orthogonal deviation (step S107).

In a case where it is determined to repeatedly execute the processing of calculating the 90-degree error amount of the IQ orthogonal deviation (YES in step S107), the repetition determination unit 244 outputs a value of the 90-degree error amount of the IQ orthogonal deviation that is input from the 90-degree error calculation unit 243 to the imperfection compensation unit 241. In a case where the value of the 90-degree error amount of the IQ orthogonal deviation is input from the 90-degree error calculation unit 243, the imperfection compensation unit 241 performs imperfection compensation on the digital signals of the I component and the Q component by using the receiver compensation value including the input value of the 90-degree error amount of the IQ orthogonal deviation (step S104). Thereafter, the processing of calculating the 90-degree error amount of the IQ orthogonal deviation is repeated (step S105 to step S106).

On the other hand, in a case where it is determined not to repeatedly execute the processing of calculating the 90-degree error amount of the IQ orthogonal deviation (NO in step S107), the repetition determination unit 244 sets the value of the 90-degree error amount of the IQ orthogonal deviation that is input from the 90-degree error calculation unit 243 to a value that is finally updated. The 90-degree error calculation unit 243 adds the finally updated value of the 90-degree error amount of the IQ orthogonal deviation to the 90-degree error amount of the IQ orthogonal deviation of the receiver compensation value (initially set in the optical hybrid circuit 11 and the equalizer 22). Thereby, the 90-degree error amount of the IQ orthogonal deviation that is set in the optical hybrid circuit 11 and the equalizer 22 is updated (step S108).

In this way, the operation of the optical receiver 1 that is related to update of the receiver compensation value and is illustrated in the flowchart of FIG. 6 is ended.

As described above, the optical receiver 1 according to each embodiment of the present invention includes the 90-degree error detection unit that calculates the 90-degree error amount of the IQ orthogonal deviation of the optical hybrid circuit as angle information (an angle error) and updates the receiver compensation value (initially set value) of at least one of the optical hybrid circuit or the equalizer by adding the calculated value and the receiver compensation value which is initially set.

With such a configuration, the optical receiver 1 according to each embodiment of the present invention can estimate the 90-degree error amount of the IQ orthogonal deviation of the optical hybrid circuit without using a known reference signal, and can feed back the estimated value to the optical hybrid circuit or update the compensation value to be used in the digital signal processing unit (equalizer) having a configuration in the related art by using the estimated value.

Thereby, the optical receiver 1 according to the embodiment of the present invention can perform compensation of the IQ orthogonality error of the optical hybrid circuit with higher accuracy. Thus, it is possible to reduce a deterioration in signal quality and implement optical communication with a higher quality. In addition, in the optical transmission system including the optical receiver 1 according to the embodiment of the present invention, it is not necessary to use a known reference signal, and thus, it is possible to perform compensation of an IQ orthogonality error even during an operation of the optical transmission system.

In addition, with such a configuration, the optical receiver 1 according to each of the embodiments of the present invention does not need to add a new equalizer unlike the technique in the related art in which compensation processing is performed using a known reference signal. Therefore, it is possible to improve accuracy of estimation of the IQ orthogonality error while preventing the configuration of the digital signal processing from being complicated.

According to the above-described embodiment, the optical receiver includes an acquisition unit (an acquirer) and an error detection unit (an error detector). For example, the optical receiver is the optical receiver 1 according to the embodiment, the acquisition unit (an acquirer) is the digital signal processing unit 20 according to the embodiment, and the error detection unit (an error detector) is the 90-degree error detection unit 24 (the 90-degree error detection unit (X side) 24-1 and the 90-degree error detection unit (Y side) 24-2) and the 90-degree error detection unit 24a (the 90-degree error detection unit (X side) 24a-1 and the 90-degree error detection unit (Y side) 24a-2) according to the embodiment.

The acquisition unit acquires a signal indicating an in-phase component and a signal indicating a quadrature component for each of the polarized waves of the received light. For example, the received light is signal light according to the embodiment, the polarized waves are the X polarized wave and the Y polarized wave according to the embodiment, and the signal is an electrical signal for each of the polarized waves and for each of the IQ components according to the embodiment.

The error detection unit detects, as an angle error, a deviation in orthogonality between an in-phase component and a quadrature component which are generated in an optical hybrid circuit that performs coherent detection of received light based on the signals, and updates a setting value to be used for compensation processing of the deviation in orthogonality in at least one of the optical hybrid circuit or the equalizer based on the angle error. For example, the optical hybrid circuit is the optical hybrid circuit 11 according to the embodiment, the angle error is an output value of the 90-degree error calculation unit 243 according to the embodiment, the equalizer is the equalizer 22 (the equalizer 22-1 and the equalizer 22-1) according to the embodiment, and the setting value is the receiver compensation value according to the embodiment.

Note that, in the optical receiver, the error detection unit (the error detector) may perform repetition processing of repeatedly calculating the deviation in orthogonality by using the detected angle error and update the setting value to a value of the angle error that converges by the repetition processing. For example, the repetition processing is processing executed by the repetition determination unit 244 according to the embodiment.

Note that, in the optical receiver, the error detection unit (the error detector) may calculate a coefficient that compensates for a deviation in symmetry between the in-phase component and the quadrature component based on the signals and detects the deviation in orthogonality as the angular error by extracting the angular error from the coefficient. For example, the coefficient is a WL compensation coefficient W according to the embodiment.

Note that, in the optical receiver, the error detection unit (the error detector) may calculate the angle error based on a following calculation expression.

$$θ = arg ∠ [ ( 1 + w ) / ( 1 - w ) ]$$

Here, W represents the coefficient, θ represents the angle error, and arg ∠[.] represents a deflection angle of a complex number.

Note that, in the optical receiver, the error detection unit (the error detector) may calculate the coefficient based on a setting value that is set in the equalizer and is to be used for the compensation processing. For example, the setting value is the receiver compensation value according to the embodiment.

Note that, in the optical receiver, the error detection unit (the error detector) may calculate the coefficient based on a following calculation expression.

$$W = - E [ ( . ) 2 ] / 2 E [ \vert . \vert ]$$

Here, W represents the coefficient, |.|represents an absolute value, and E[.] represents an expected value. Note that the calculation expression is a calculation expression corresponding to expression (24) of Non Patent Literature 1.

A part of the optical receiver 1 according to the embodiment may be implemented by a computer. In that case, a program for implementing the functions may be recorded in a computer-readable recording medium, and the functions may be implemented by loading the program recorded in this recording medium to a computer system, and executing the program. Note that, the “computer system” referred to herein includes an OS and hardware such as peripheral equipment. In addition, the “computer-readable recording medium” refers to a portable medium such as a flexible disk, a magneto-optical disc, a ROM, or a CD-ROM or a storage device such as a hard disk included in the computer system.

Further, the “computer-readable recording medium” may include a medium that dynamically holds the program for a short time, such as a communication line in a case where the program is transmitted via a network such as the Internet or a communication line such as a telephone line, and a medium that holds the program for a certain period of time, such as a volatile memory inside a computer system serving as a server or a client in that case. The above program may be for implementing some of the functions described above, may implement the functions described above in combination with the program already recorded in the computer system, or may be implemented by using a programmable logic device such as a field programmable gate array (FPGA).

Although the embodiments of the present invention have been described in detail with reference to the drawings, specific configurations are not limited to the embodiments and include design and the like without departing from the gist of the present invention.

### REFERENCE SIGNS LIST

1 Optical receiver
10 Optical coherent detection unit
11 Optical hybrid circuit
12 Balanced photo detector and trans-impedance amplifier (BPD+TIA)
20 Digital signal processing unit
21 Analog-to-digital converter (ADC)
22 Equalizer
23 Adaptive equalization unit
24 90-degree error detection unit
241 Imperfection compensation unit
242 WL compensation coefficient calculation unit
243 90-degree error calculation unit
244 Determination unit

1. An optical receiver comprising:
an acquirer that acquires a signal indicating an in-phase component and a signal indicating a quadrature component for each of polarized waves of received light; and
an error detector detects, as an angle error, a deviation in orthogonality between the in-phase component and the quadrature component based on the signals, the components being generated in an optical hybrid circuit that performs coherent detection of the received light, and updates a setting value to be used for compensation processing of the deviation in orthogonality in at least one of the optical hybrid circuit or an equalizer based on the angle error.

2. The optical receiver according to claim 1, wherein
the error detector performs repetition processing of repeatedly calculating the deviation in orthogonality by using the detected angle error, and updates the setting value to a value of the angle error that converges by the repetition processing.

3. The optical receiver according to claim 1, wherein
the error detector calculates a coefficient that compensates for a deviation in symmetry between the in-phase component and the quadrature component based on the signals, and detects the deviation in orthogonality as the angular error by extracting the angular error from the coefficient.

4. The optical receiver according to claim 3, wherein
the error detector calculates the angle error based on a following calculation expression,
$$θ = arg ∠ [ ( 1 + W ) / ( 1 - W ) ]$$
here, W represents the coefficient, θ represents the angle error, and arg ∠[.] represents a deflection angle of a complex number.

5. The optical receiver according to claim 3, wherein
the error detector calculates the coefficient based on a setting value that is set in the equalizer and is to be used for the compensation processing.

6. The optical receiver according to claim 3, wherein
the error detector calculates the coefficient based on a following calculation expression,
$$W = - E [ {( . )}^{2} ] / 2 E [ \vert . \vert ]$$
here, W represents the coefficient, |.|represents an absolute value, and E[.] represents an expected value.

7. A signal processing method causing a computer of an optical receiver to execute a process comprising:
acquiring an electrical signal indicating an in-phase component and an electrical signal indicating a quadrature component for each of polarized waves of received light;
detecting, as an angle error, a deviation in orthogonality between the in-phase component and the quadrature component based on the electrical signals, the components being generated in an optical hybrid circuit that performs coherent detection of the received light; and
updating a setting value to be used for compensation processing of the deviation in orthogonality in at least one of the optical hybrid circuit or an equalizer based on the angle error.
